(19) United States
(12) Patent Application Publication
(10) Pub. No.: US 2015/0008906 A1
(43) Pub. Date: Jan. 8, 2015

(54) POSITION SENSING DEVICE

(71) Applicants: DENNIS K. BRIEFER, BERLIN, MA (US); STEVEN BEARD, BERLIN, MA (US)

(72) Inventors: DENNIS K. BRIEFER, BERLIN, MA (US); STEVEN BEARD, BERLIN, MA (US)

(21) Appl. No.: 14/305,605

(22) Filed: Jun. 16, 2014

Related U.S. Application Data
(60) Provisional application No. 61/842,603, filed on Jul. 3, 2013.

(51) Int. Cl. G01D 5/20; G01B 7/14; G01B 7/00

(52) U.S. Cl. CPC G01D 5/2006; G01B 7/003; G01B 7/14
USPC 324/207.17

(57) ABSTRACT

A device for measuring relative distance between two physical objects includes an elongated inductor coil and a movable core. The movable core includes a slug of magnetically interactive material and is configured to move within the elongated inductor coil and to couple and interact magnetically with the elongated inductor coil. Electric current flowing through the elongated inductor coil generates a magnetic flux within the elongated inductor coil, and the magnetic flux is subsequently modified by moving the movable core within the elongated inductor coil and the modified magnetic flux is used to produce an electric output as a function of the position of the slug within the elongated inductor coil.

### CROSS REFERENCE TO RELATED CO-PENDING APPLICATIONS

This application claims the benefit of U.S. provisional application Ser. No. 61842603 filed on Jul. 3, 2013 and entitled POSITION SENSING DEVICE, which is commonly assigned and the contents of which are expressly incorporated herein by reference.

### FIELD OF THE INVENTION

The present invention relates to a position sensing device, and in particular to a device that uses a variable inductance sensor for measuring relative position.

### BACKGROUND OF THE INVENTION

There are many prior art devices for measuring relative position including ultrasonic devices, optical encoders, and linear variable differential transformers (LVDT). The performance of ultrasonic devices and optical encoders are highly influenced by the medium in which they operate. The linear variable differential transformer devices are expensive, and require multiple coils in precise positions.

Accordingly, a low cost position sensor that has high accuracy is desirable.

### SUMMARY OF THE INVENTION

This invention relates to sensors for measuring relative distance between two physical objects. One form of this invention relates to sensors in which magnetic coupling is used to produce an electric output as a function of distance. This is done by providing a relatively large air gap between the movable core and the shield of the unit, when a shield is used, and through the use of a precision wound helical sensing coil with corrected native linearity.

In general, one aspect of the invention provides a device for measuring relative distance between two physical objects including a sensor comprising an elongated inductor coil and a movable core. The movable core includes a slug of magnetically interactive material and is configured to move within the elongated inductor coil and to couple and interact magnetically with the elongated inductor coil. Electric current flowing through the elongated inductor coil generates a magnetic flux within the elongated inductor coil, and the magnetic flux is subsequently modified by moving the movable core within the elongated inductor coil and the modified magnetic flux is used to produce an electric output as a function of the position of the slug within the elongated inductor coil.

Implementations of this aspect of the invention include the following. The elongated inductor coil includes windings with a pitch that varies along the elongated inductor coil length. The slug comprises a ferromagnetic material. The movable core includes a shaft and the magnetically interactive material is attached to an outer surface of the shaft. The device further includes a drive element configured to drive the shaft of the movable core linearly within the elongated inductor coil. The magnetically interactive material is attached to the outer surface of the shaft with an adhesive, or via press-fitting. The device further includes a shield surrounding the elongated inductor coil and movable core. The shield comprises a ferromagnetic material and conducts a return magnetic flux. The elongated inductor coil comprises windings with a constant pitch and the windings begin at one end of the shield and end internal to a second end of the shield. The elongated inductor coil comprises windings with a constant pitch and the winding begin internal to one end of the shield and end internal to a second end of the shield. The elongated inductor coil comprises windings with a variable pitch and the windings begin at one end of the shield and end at a second end of the shield. The elongated inductor coil comprises windings arranged so that a time constant of the elongated inductor coil is a predetermined function of the position of the movable core. The device further includes a time constant network configured to generate an oscillation having a period proportional to a time constant of the elongated inductor coil. The device further includes a linearization network connected to an output of the time constant network and configured to generate a linear transfer function between the period of the time constant network oscillation and the time constant of the elongated inductor coil. The device further includes an output network connected to an output of the time constant network or the linearization network and configured to provide an output signal that is amplified and corrected for environmental conditions. The slug comprises a conductive material that excludes the magnetic flux.

In general, another aspect of the invention provides a device for measuring relative distance between two physical objects including a sensor comprising an inductive circuit and the inductive circuit includes an inductor and a slug of magnetically interactive material. The relative distance between the inductor and the slug of magnetically interactive material is measured by varying a time constant of the inductive circuit. The inductance of the inductor varies as a function of the slug position relative to the inductor and thereby affects the time constant of the inductive circuit. The inductor includes helical windings and is encased within a ferromagnetic material. The inductor includes windings with variable pitch and the inductance of the inductor varies linearly with the position of the slug within the inductor. The inductive circuit further includes a resistor and a capacitor. The inductive circuit further includes a Colpitts oscillator.

In general, another aspect of the invention provides a method for measuring relative distance between two physical objects including providing a sensor comprising an elongated inductor coil and a movable core. The movable core includes a slug of magnetically interactive material and is configured to move within the elongated inductor coil and to couple and interact magnetically with the elongated inductor coil. Electric current flowing through the elongated inductor coil generates a magnetic flux within the elongated inductor coil, and the magnetic flux is subsequently modified by moving the movable core within the elongated inductor coil and the modified magnetic flux is used to produce an electric output as a function of the position of the slug within the elongated inductor coil.

Among the advantages of this invention may be one or more of the following. Magnetic linear motion sensors are useful for a variety of motion sensing tasks such as measuring the position of valves, automated assembly equipment, balancing machines, strength testing, liquid level, structure testing, actuator position sensing, valve position, thickness control, wind power generators, earth moving equipment components and hydraulic cylinders.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

FIG. 1 is a schematic diagram of a position sensing device according to this invention;

FIG. 2 is a schematic diagram of the position sensing device of FIG. 1 having the measuring electronics and magnetic assembly contained within one housing;

FIG. 3 shows a partially schematic and partially cutaway view of the position sensing device of FIG. 1;

FIG. 4 is a cross sectional view of one embodiment of the position sensing device of FIG. 1, where the pitch of coil 26 changes as a function of position within component 25;

FIG. 5 is a cross sectional view of another embodiment of the position sensing device of FIG. 1, where coil 26 begins at one end of component 25 and ends internal to the distal end of component 25;

FIG. 6 shows an electrical diagram of an embodiment of the present invention;

FIG. 7 shows an electrical diagram of another embodiment of the present invention;

FIG. 8 shows an electrical diagram of another embodiment of the present invention; and

FIG. 9 shows an electrical diagram of another embodiment of the present invention.

### DETAILED DESCRIPTION OF THE INVENTION

A position sensing device includes a magnetic assembly positioned in relation to a slug of material which modifies the inductance of the magnetic assembly as the position of the slug changes in relation to the magnetic assembly. The magnetic assembly includes an electrical conductor and preferably magnetic conductors which guide the magnetic fields so that as the slug is displaced in relation to the magnetic assembly the inductance of the magnetic assembly changes. The sensor may be a portion of an inductive time constant circuit such that the time constant varies as a function of the position of the slug.

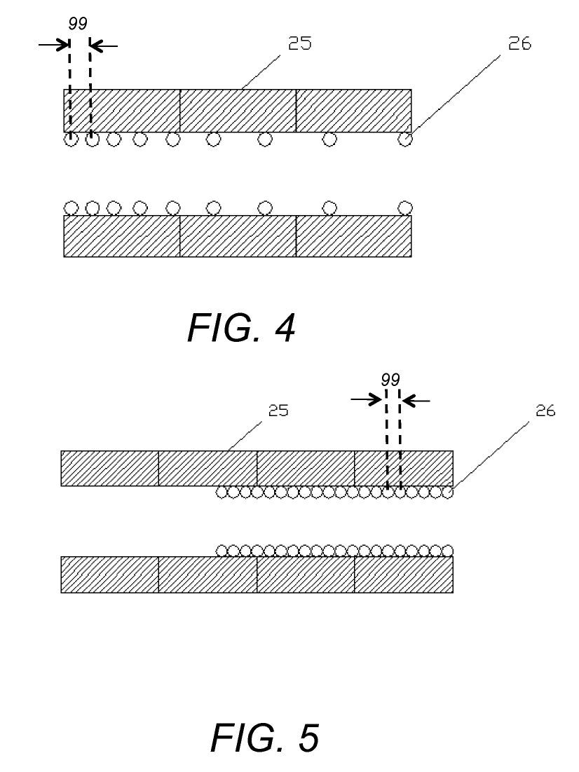

This invention measures distance by varying the time constant of an inductive circuit. In an RL type circuit the time constant τ is equal to L/R, where L is the inductance and R the resistance of the circuit. The time constant of the inductive circuit is changed by changing the inductance of a magnetic assembly according to the relative position of a slug of ferromagnetic or conductive material. In one embodiment, the invention uses an inductive coil that is wound with a controlled pitch 99 as function of the position along the associated magnetic coil, as shown in FIG. 5. The pitch 99 of a coil is the distance between the centers of two adjacent windings. In this embodiment, the inductance L of the magnetic coil varies as a function of the slug 27 position and thereby affects the time constant τ of the circuit. This sensor arrangement is used for measuring the position of a slug 27 relative to the coil 26. This sensor arrangement is simpler than LVDT position sensors and is more cost effective. This arrangement is also advantageous for measuring longer stroke lengths than the stroke lengths measured with LVDT position sensors. This arrangement also allows the sensor to be shorter than the corresponding LVDT unit. The use of time constant electronics with this sensor arrangement allows the output period of the combined sensor and electronics to have a large linear transfer function range. In one embodiment, the coil 26 is helical and is encased with a ferromagnetic material 25 which conducts the return flux. The coil's magneto-motive force generates a field within the active part of the coil 26 which is modified by the position of the slug 27. In another embodiment, the coil is wound with a variable pitch 99 so that the inductance L varies linearly as a ferromagnetic or conductive slug modifies the flux from an increasing number of turns as the slug moves into a portion of the coil with higher turns density, as shown in FIG. 4. A further refinement of the invention arranges the turn's density of the coil such that the time constant of the circuit is a predetermined function of the position of the slug.

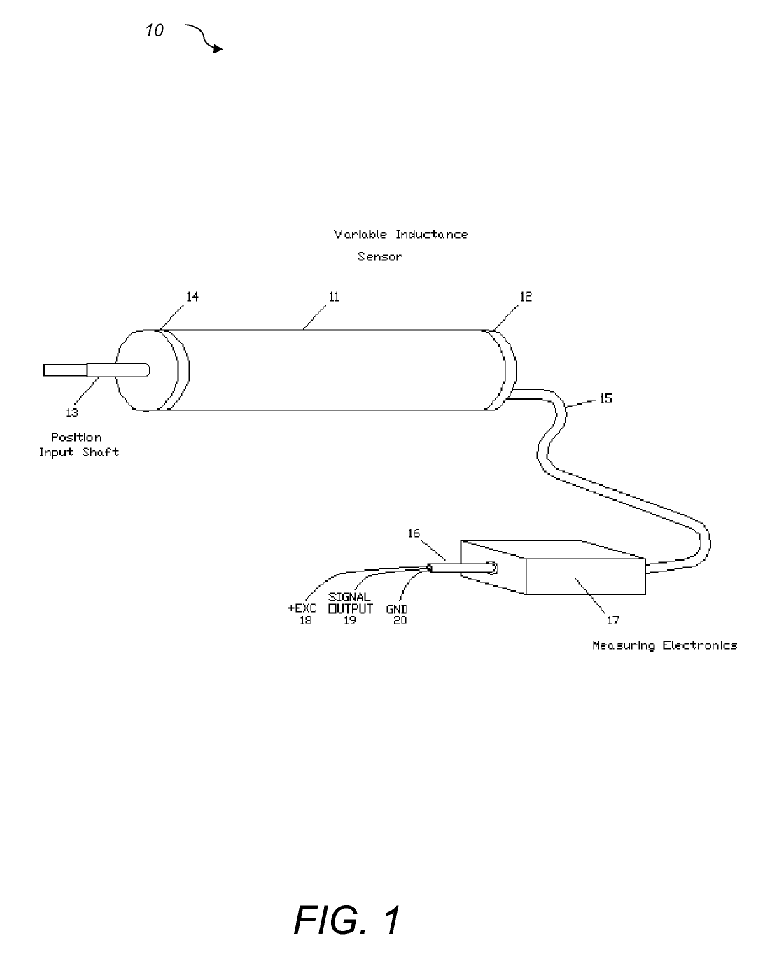

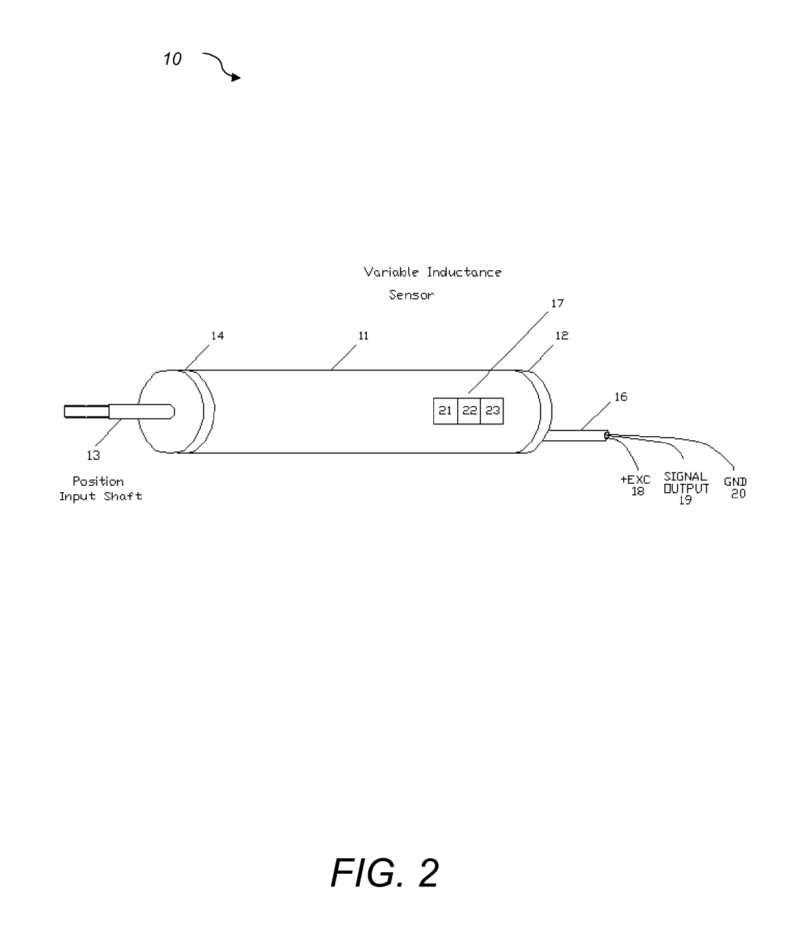

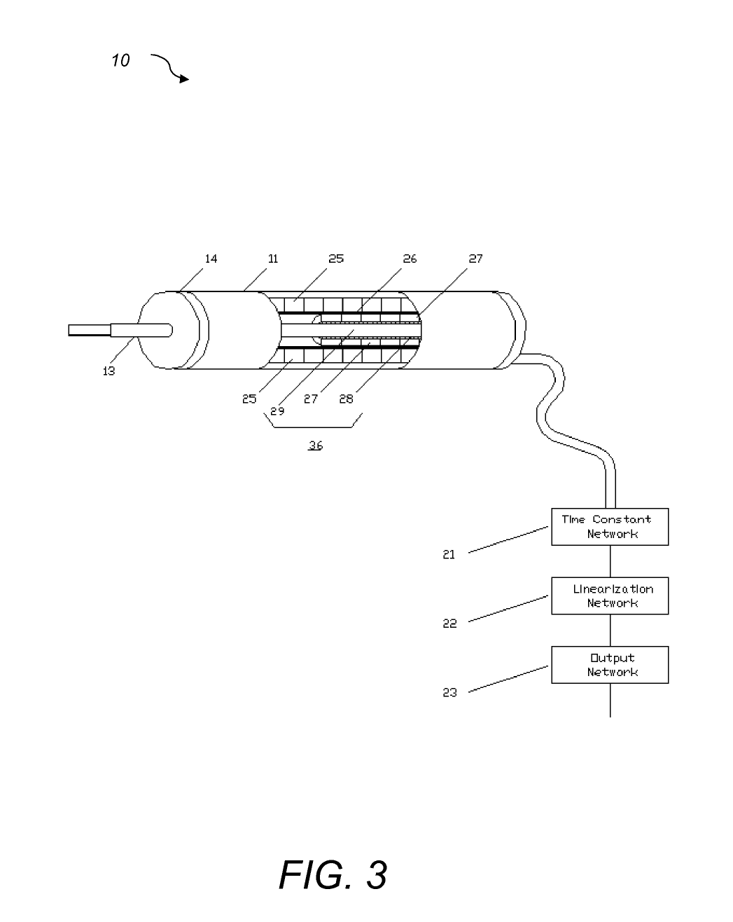

Referring to FIG. 1 and FIG. 2, displacement sensor 10 includes housing 11, end caps 12 and 14, sensor head cable 15, signal and excitation cable 16, together with combined measuring electronics 17 and associated power input terminal 18, power and signal return terminal 20 and signal output terminal 19. The simplest form of this invention includes a movable slug 27 of magnetically interactive material which interacts with elongated inductor 26 and shield 25 in the active magnetic assembly together with measuring electronics 17, as shown in FIG. 3.

FIG. 2 shows a variable inductance sensor with the measuring electronics contained within one housing.

Referring to FIG. 3, sensor 10 includes a rigid housing 11, supporting outer material 25, coil 26 and movable slug 27. In some embodiments, outer material 25 is ferromagnetic and conducts flux generated by coil 26. Current flowing through coil 26 generates magnetic flux that is modified by moving slug 27 into or out of the coil 26. Moving slug 27 relative to coil 26 changes the magnetic flux according to the relative position of the slug 27 in the coil 26. Probe assembly 36, includes probe active material 27, glue 28 if required, and distal shaft 29 that is driven by shaft 13. The glue 18, is usually an epoxy. In other embodiments, press fit is used, instead of glue 28. Sensor 10 also includes a time constant network 21, a linearization network 22 and output network 23. These networks include digital or analog components. The inductance L of this sensor construction, when the core, or slug, or probe material 27 is ferrite is almost entirely governed by the number of turns squared (N²) adjacent to the core 27. If the inductance ratio from one end of travel of the core to the other end is 3:1 then the turns ratio from one end to the other is the square root of three, or 1.732. Since obtaining the highest inductance for a given core length is useful, the turns density at the densest end is that obtainable with the turns almost touching. The density at the lowest end is 1/1.732 of that. In between the ends, the turn's density is such that the output period is linear with the motion of the core, or some other desired transfer function. The core 27 is usually made of ferrite that is stable to the desired operating range, but can be conductive material that excludes flux, thereby altering the inductance, especially in the shorter stroke sensors. The proximal shaft 13 and distal shaft 29 are typically titanium, stainless or aluminum.

FIG. 4 shows a section view of material 25 outside of the helical conductor where the pitch of coil 26 changes as a function of position within material 25.

In one example, the diameter of coil 26 is 0.34 inches. This diameter can be varied easily if desired. The length of the coil is typically 10 mm to 1 meter, depending on the intended measurement range. The shield 25 is typically made of the same ferrite as the core 27. In lower cost sensor units or in longer range sensors, shield 25 is made of permeability 1 material.

FIG. 5 shows a coil 26 beginning at one end of material 25 and ending internal to the distal end of material 25. Another embodiment includes a coil 26 beginning internal to material 25 and ending either flush with the distal end of material 25 or internal to the distal end of material 25.

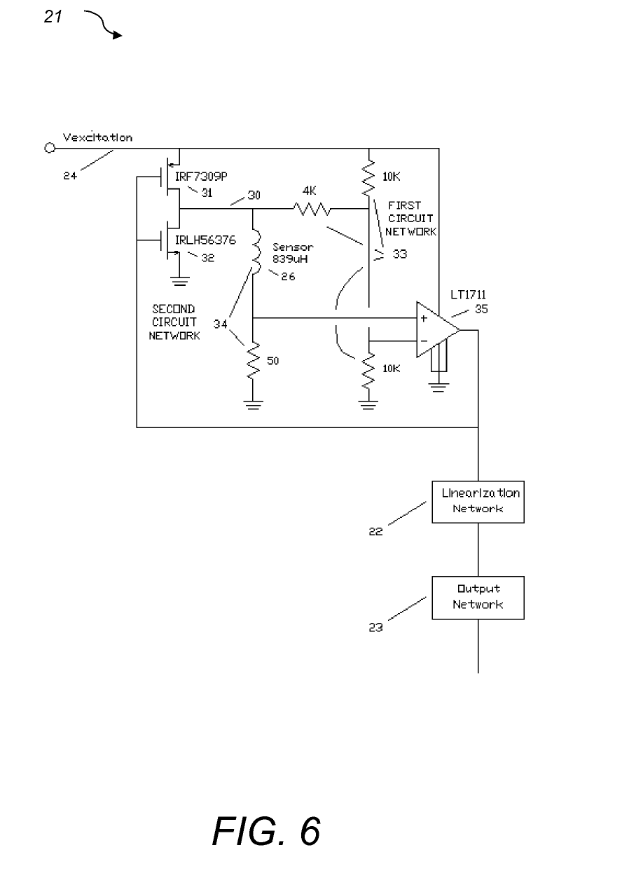

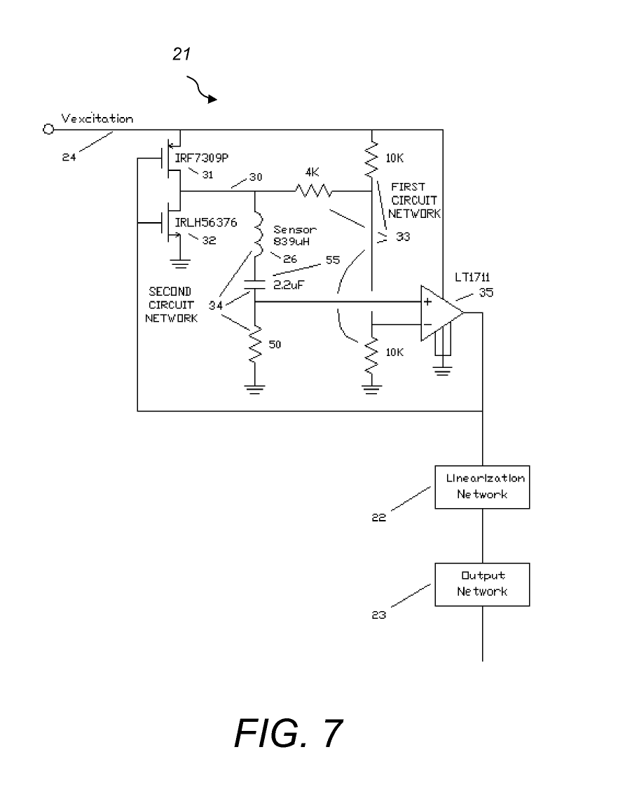

FIG. 6 and FIG. 7 show electrical circuit schematic diagrams of the present invention. An output terminal 30 is driven by a first electronic switch 31 and second electronic switch 32. When output terminal 30 is driven to a voltage near Vexcitation 24 by switch 31 current builds in coil 26 increasing the voltage at the positive input of comparator 35 relative to the voltage at the negative comparator input. Eventually the voltage at the positive input of the comparator using the second circuit network 34 becomes higher than the voltage at the negative input of the comparator and the output of the comparator goes to a level near the excitation voltage 24. This causes the switches 31 and 32 to change state, driving the voltage at output terminal 30 to a level near ground. The resulting change of voltages at the inputs of the comparator through the first circuit network 33 reinforces this change in state until reversal of the direction of current in coil 26 changes the state of switches 31 and 32 back to the beginning of this cycle. The comparator 35 may be made of either analog or logic elements. This operation causes the period of the resulting oscillation to be nearly proportional to the time constant t of the inductance L of the sensor 26 and the resistance R of resistor 50. FIG. 7 shows a variation of the electrical circuit 21 which reduces the excitation current 24 through the use of the capacitor 55 in the second circuit network. A linearization network 22 can be connected to the output of time constant network 21 if a more linear transfer function is required for an application. Alternatively, by making the turns density of the inductor a predetermined function of the position along the sensor, a wide variety of transfer functions can be obtained. An output network 23 can be connected to the output of time constant network 21 or to the output of the linearization network 22 to provide an output signal with higher amplitude, correction for environmental conditions or other signal translations. It is also possible to correct for changes in the sensing inductor separately from the other electronics by measuring the temperature of the inductor. The temperature of inductor 26 may be measured either by measuring its resistance, or by using a separate temperature sensor in close proximity to the sensing inductor 26. Measurement of the electronic temperature to compensate for the non-inductive components may also be made to compensate for the temperature effect they have on the operation of the complete sensor. The inductance L is typically a linear function of the position of core 27, with a non-zero starting point for the inductance. The output signal can have many formats. In many cases, a 0 to 5 volt range, or a +/−5 volt range or a 0 to 10 volt range is desired. The output signal may also be a digital format or analog format current.

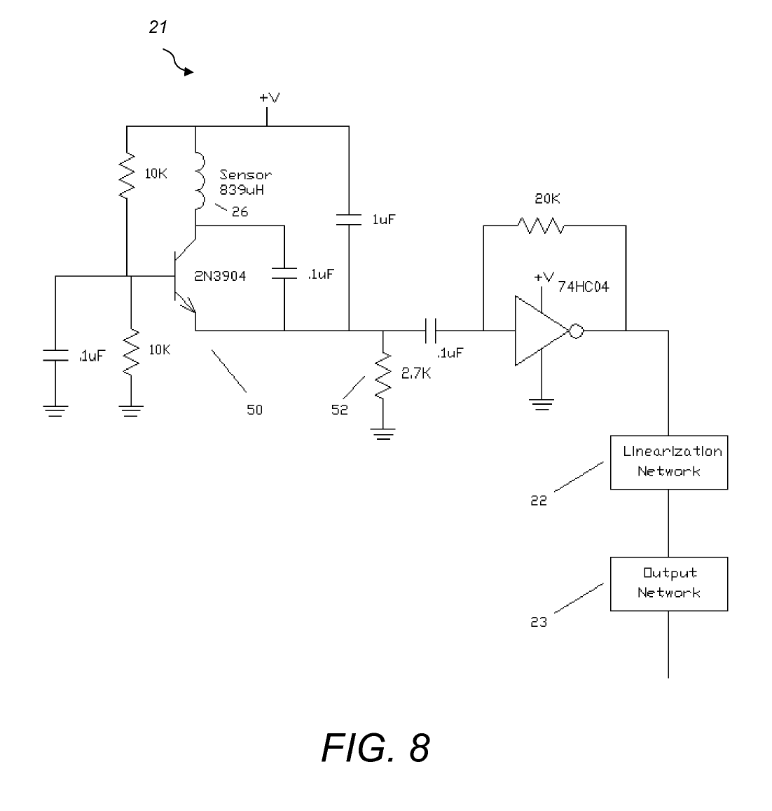

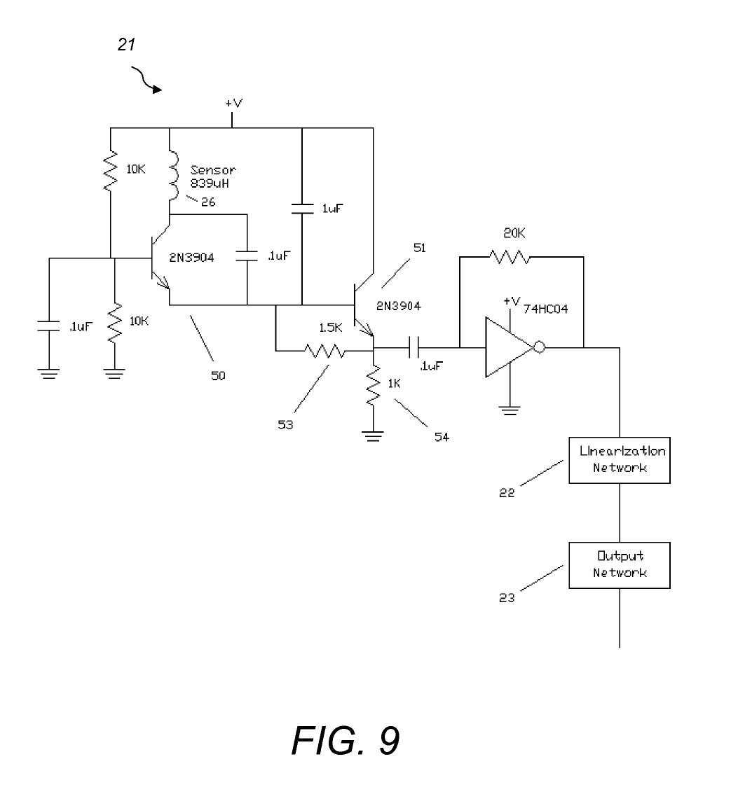

FIG. 8 shows an electrical circuit schematic diagram of the present invention where the inherent superior linearity obtained using the circuits of FIG. 6 and FIG. 7 can be sacrificed to allow lower power operation. In this embodiment a Colpitts oscillator using a bipolar transistor 50 and a current determining resistor 52 causes the transistor to stay out of a saturated collector-emitter voltage condition. This eliminates saturation delay in that transistor, allowing the circuit to faithfully operate at the resonant frequency of the combined sensor inductor and the series capacitance of the collector-emitter capacitor and the emitter-supply capacitor. The gain limitation required for any oscillator is provided by the emitter cutoff condition of the transistor during a portion of the operating cycle, which is inherently a fast mode of operation with minimal phase shift. One version of this circuit also has a constant current sink to bias the emitter of the oscillator transistor. Referring to FIG. 9, one version of the constant current sink uses the base-emitter voltage of a second transistor 51 with an accompanying resistor 53 to provide an essentially constant current sink for transistor 50. Resistor 54 sinks both the oscillator current and the collector current in transistor 51.

Several embodiments of the present invention have been described. Nevertheless, it will be understood that various modifications may be made without departing from the spirit and scope of the invention. Accordingly, other embodiments are within the scope of the following claims.

What is claimed is:

1. A device for measuring relative distance between two physical objects comprising:
a sensor comprising an elongated inductor coil and a movable core;
wherein the movable core comprises a slug of magnetically interactive material and is configured to move within the elongated inductor coil and to couple and interact magnetically with the elongated inductor coil; and
wherein electric current flowing through the elongated inductor coil generates a magnetic flux within the elongated inductor coil, and the magnetic flux is subsequently modified by moving the movable core within the elongated inductor coil and the modified magnetic flux is used to produce an electric output as a function of the position of the slug within the elongated inductor coil.

2. The device of claim 1, wherein the elongated inductor coil comprises windings with a pitch that varies along the elongated inductor coil length.

3. The device of claim 1, wherein the slug comprises a ferromagnetic material.

4. The device of claim 1, wherein the movable core comprises a shaft and wherein the magnetically interactive material is attached to an outer surface of the shaft.

5. The device of claim 4, further comprising a drive element configured to drive the shaft of the movable core linearly within the elongated inductor coil.

6. The device of claim 4, wherein the magnetically interactive material is attached to the outer surface of the shaft with an adhesive.

7. The device of claim 4, wherein the magnetically interactive material is attached to the outer surface of the shaft via press-fitting.

8. The device of claim 1, further comprising a shield surrounding said elongated inductor coil and movable core.

9. The device of claim 8, wherein the shield comprises a ferromagnetic material and conducts a return magnetic flux.

10. The device of claim 8, wherein the elongated inductor coil comprises windings with a constant pitch and beginning at one end of the shield and ending internal to a second end of the shield.

11. The device of claim 8, wherein the elongated inductor coil comprises windings with a constant pitch and beginning internal to one end of the shield and ending internal to a second end of the shield.

12. The device of claim 8, wherein the elongated inductor coil comprises windings with a variable pitch and beginning at one end of the shield and ending at a second end of the shield.

13. The device of claim 8, wherein the elongated inductor coil comprises windings arranged so that a time constant of the elongated inductor coil is a predetermined function of the position of the movable core.

14. The device of claim 1, further comprising a time constant network configured to generate an oscillation having a period proportional to a time constant of the elongated inductor coil.

15. The device of claim 14, further comprising a linearization network connected to an output of the time constant network and configured to generate a linear transfer function between the period of the time constant network oscillation and the time constant of the elongated inductor coil.

16. The device of claim 15, further comprising an output network connected to an output of the time constant network or the linearization network and configured to provide an output signal that is amplified and corrected for environmental conditions.

17. The device of claim 1, wherein the slug comprises a conductive material that excludes the magnetic flux.

18. A device for measuring relative distance between two physical objects comprising:
a sensor comprising an inductive circuit and wherein the inductive circuit comprises an inductor and a slug of magnetically interactive material and wherein relative distance between the inductor and the slug of magnetically interactive material is measured by varying a time constant of the inductive circuit.

19. The device of claim 18, wherein an inductance of the inductor varies as a function of the slug position relative to the inductor and thereby affects the time constant of the inductive circuit.

20. The device of claim 18, wherein the inductor comprises helical windings and is encased within a ferromagnetic material.

21. The device of claim 18, wherein the inductor comprises windings with variable pitch and an inductance of the inductor varies linearly with the position of the slug within the inductor.

22. The device of claim 18, wherein the inductive circuit further comprise a resistor and a capacitor.

23. The device of claim 22, wherein the inductive circuit further comprises a Colpitts oscillator.

24. A method for measuring relative distance between two physical objects comprising:
providing a sensor comprising an elongated inductor coil and a movable core;
wherein the movable core comprises a slug of magnetically interactive material and is configured to move within the elongated inductor coil and to couple and interact magnetically with the elongated inductor coil; and
wherein electric current flowing through the elongated inductor coil generates a magnetic flux within the elongated inductor coil, and the magnetic flux is subsequently modified by moving the movable core within the elongated inductor coil and the modified magnetic flux is used to produce an electric output as a function of the position of the slug within the elongated inductor coil.
